(19) United States
(12) Patent Application Publication
(10) Pub. No.: US 2013/0120371 A1
(43) Pub. Date: May 16, 2013

(54) Interactive Communication Virtual Space

(71) Applicant: Arthur Petit, Paris (FR)

(72) Inventor: Arthur Petit, Paris (FR)

(21) Appl. No.: 13/677,218

(22) Filed: Nov. 14, 2012

Related U.S. Application Data
(60) Provisional application No. 61/559,803, filed on Nov. 15, 2011.

(51) Int. Cl. G06T 13/40

(52) U.S. Cl. CPC G06T 13/40
USPC 345/419; 345/474

(57) ABSTRACT

An improved computer graphical interface for presenting a virtual room or space to a group of users and permitting each of the users to occupy a position in that virtual space, which is displayed to the other users as a virtual object that moves around in the virtual space based on the commands of the corresponding user. The computers operating in the simulated space share their position vectors so that the graphics and interactivity can be calculated locally. This permits a user to circulate through the space and interact with other participants in the space in a more natural, visually appealing and interactive way.

This application claims priority as a non-provisional continuation to U.S. Provisional Application No. 61/559,803 filed on Nov. 15, 2011, which is herein incorporated by reference in its entirety.

### BACKGROUND OF THE INVENTION

One application of communication among a set of computers connected to the Internet is that the computers by being connected together on a network can permit communication among the individual users of the individual computers in complex ways. One mode of communication is that all of the users can share a virtual data stream, that is, each user sees what the other users are inputting as a communication, sometimes referred to as a “chat room.” A problem with the chat room prior art is that it typically operates with text only, or that there is no easy way to move around to fully communicate through audio and video with participants present in the chat room without either inviting the entire chat room to enter another chat room, or using some other channel to invite specific participants to the other chat room. In cases of audio chat rooms, the effect is that of a conference call and is equally limiting.

There is a need for an improved interface for presenting a virtual room or simulated space to a group of users and permitting each of the users to occupy a position in that virtual space, which is displayed to the other users as a virtual object that moves around in the virtual space based on the commands of the user. Each user and at each user position in this space, is associated its own audio and video. This permits a user to circulate through the space and interact with other participants in the space in a more natural, visually appealing and interactive way.

The invention involves locally calculating the motion of the representation of actors that are occupying the virtual space by means of locally executed code that simulates a motion model to calculate and display the apparent motion. This way, each local computer that is participating in the collective environment need only receive the next position and orientation and then locally calculate the movement vector relative to the local position vector of each actor in the space. That information converted into viewable motion using the motion model, or by simple translation and orientation shifts and the local point of view into the simulated space. Additionally, audio data streams can be simulated to undergo simulated physical effects like attenuation as a function of distance. The motion model can be a simulation of actual physics or a more simple model that still provides an approximation of natural movement.

Video and image data streams can be projected into the space as well. A source of video can be projected onto designated surfaces in the simulated space. Depending on the orientation and position vectors of the simulated surface the video is projected on, as determined from the point of view of the display, the rendering is changed. In this way, a simulated object that is displaying a moving image will continue to present that image in a manner consistent with the motion and moving orientation of that object through the simulated space.

### BRIEF DESCRIPTION OF THE FIGURES

FIG. 1: Line drawing of an example view of the virtual space from a viewpoint.

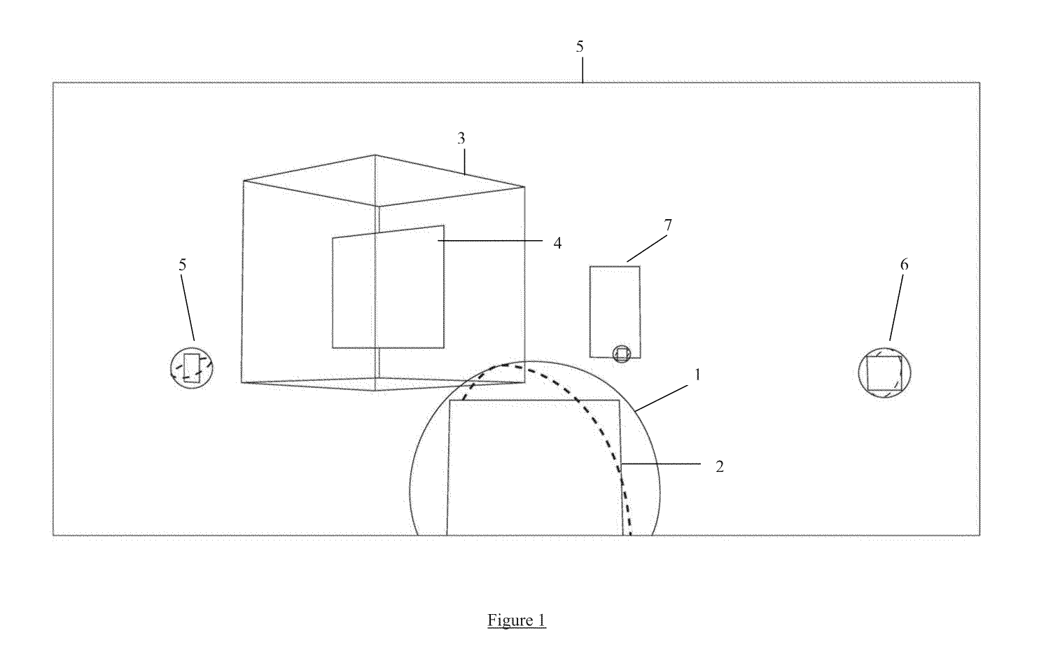

FIG. 2: Schematic of position and movement vector illustrating the handling of an automatic regulation of the video quality relatives to the distance of that video from the POV.

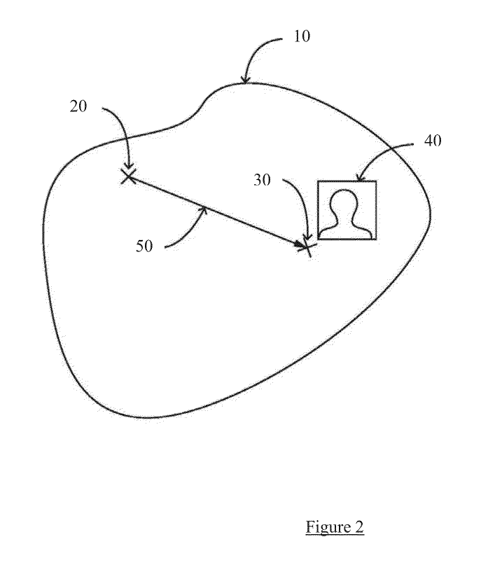

FIG. 3: Basic Architecture

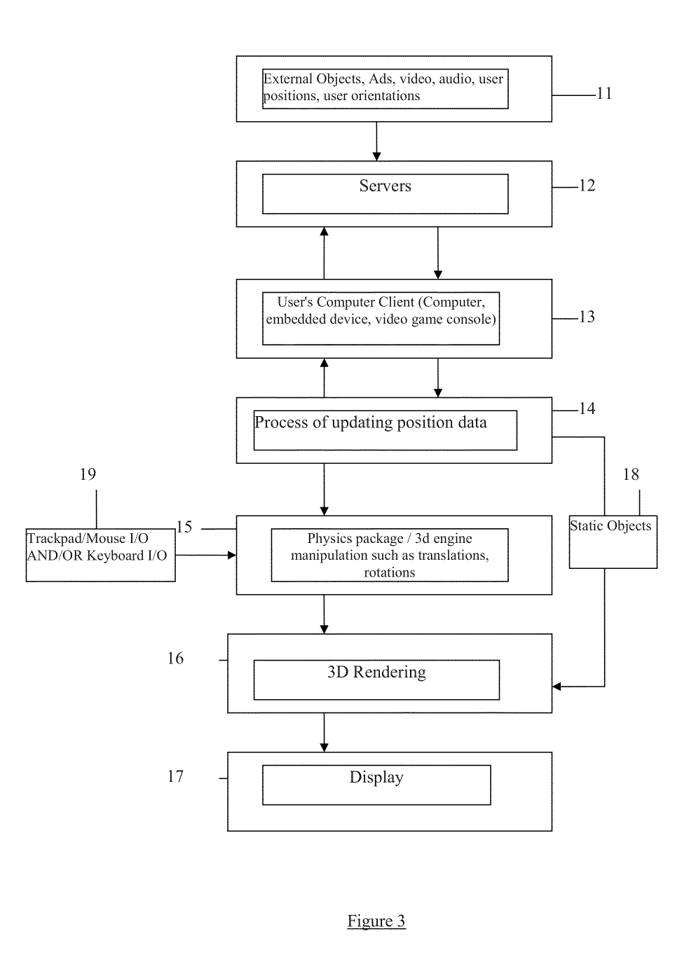

FIG. 4: A simulated image of the resulting screen.

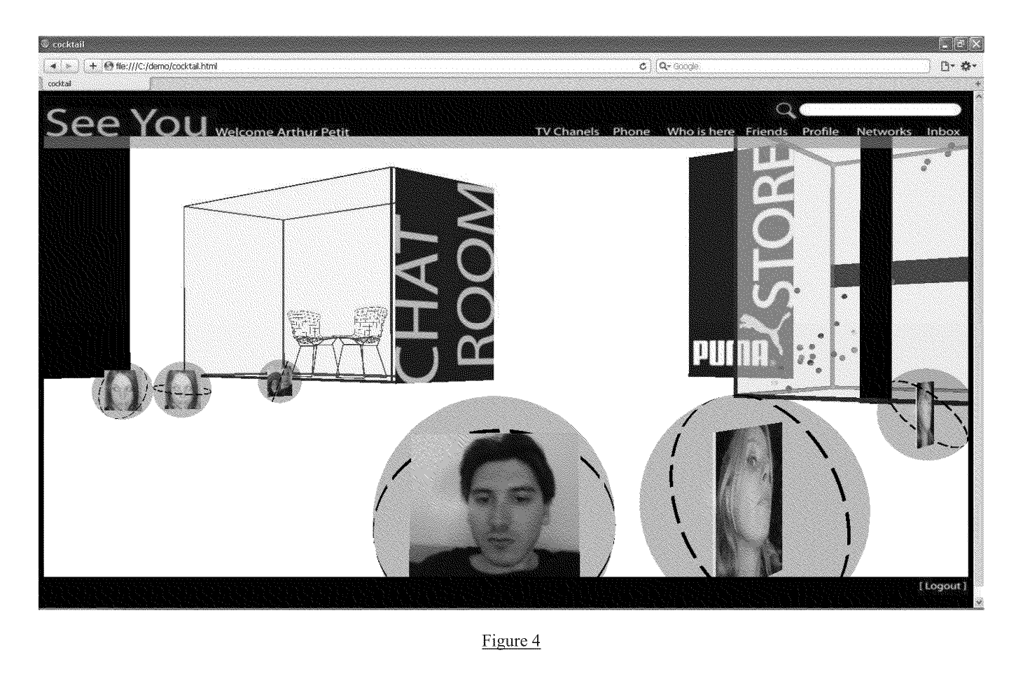

FIG. 5: Diagram of physics constraint ball that follows an actor.

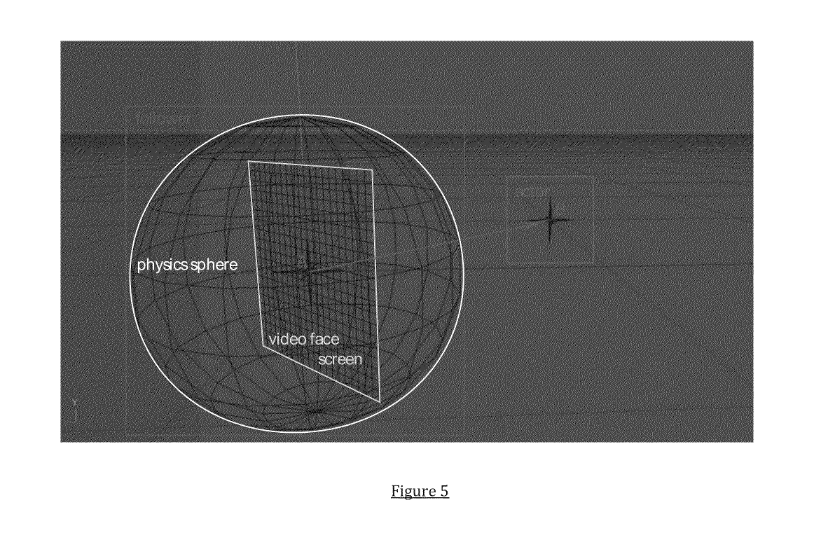

FIG. 6: Diagram of protocols for interaction between actors in a world shown in terms of the various system components.

FIG. 7: Diagram of protocols between user client computer and the actor server.

### DETAILED DESCRIPTION OF THE PREFERRED EMBODIMENT

A user operating a computer adapted to embody the invention opens an application that opens a virtual window on the user's computer screen. In one embodiment, the application is an Internet web browser program. When the user initiates participation in the virtual or simulated space, a three dimensional view rendered to the two dimensional screen is presented in the window (5). The explanation will now describe the apparent objects the user sees, while it is understood that these are virtual objects that are rendered as graphics on the screen of the user's computer.

The user is represented in the space as a geometric object floating above a surface. In one embodiment, the object is a sphere, (1), drawn as an outline to appear three dimensional. Floating within the object is an image frame, (2), which, in the preferred embodiment is a flat square with three dimensional attributes, essentially like a wafer, which can turn and either face the viewer or face away. In the preferred embodiment, each user is represented as a transparent floating sphere with a square image frame floating within it that has the user's picture on it (40).

Each user occupies a position along the surface. (1). A user looking into the screen sees the apparent position of other participants out in the space as viewed from the point of view of that user. The graphics are presented so that a participant whose position is furthest away has a smaller looking object representation as compared to a participant that is closer. (5), (6). This is all calculated to reinforce the three dimensionality of the space. A user can move the position of their object representative. In the preferred embodiment, the user can use a mouse, track pad, keyboard, or any other input device (19) connected to the computer they are operating to impart motive force, with a direction, on the sphere. In one embodiment, the input device causes a position vector of the actor to be changed, and the difference between the actor position vector and the actor object position vector is used to create a motion vector that causes the actor object to move toward the actor position.

The sphere will move across the surface and simultaneously, the display window (5) will show the background objects and the surface moving as if the window was a camera following the moving sphere. The point of view of the user's computer may track that user's actor object as it moves through the space. The sphere will behave within the context of a physical model, that is, the computer rendering the sphere's movement will impart momentum and mass to the sphere so that it bounces off other objects or travels in particular ways that feel natural.

Other objects can occupy the space. For example, there can be a virtual geometric solid object rising from the surface. (7). That solid has a face, and video can be displayed from that face. (7). As the user's object representation passes the rectangular object, the perspective may change, and the relative angle of the face of the rectangular object will change. As that angle changes, the projection of the video onto that face will change in tandem in order to give the appearance of passing by a video screen.

Audio can be handled by application of a local physical model. The user can utilize a microphone attached to their computer to create an audio stream that is broadcast to all of the participant's computers in order to input sounds into the space. The source of sound can be considered by the model to be the location of the actor object. Therefore, the audio stream, just like in a real physical environment, can be attenuate more the further away it gets from the point of view of the rendering computer. In this way, when two actors are close, one participant can hear what the other is saying. However, actors that are relatively distant will not hear each other. Groups of participants that are close together will experience a group conversation, but by drifting away from the group, a participant will hear less and less of the group conversation and more of whatever is closer to that participant. In addition, virtual walls can be created, whereby visually there is a set of rectangles or other objects that block viewing and further block sound from object representations whose location is on the other side of the wall. Any sound source, including sound that accompanies video data streams can be treated the same way.

As noted, the above describes the appearance of the environment when the computer system adapted in accordance with the invention presents the environment to one or more users through their individual computers. The computer system is comprised of one or more computers with a data storage device operatively connected to the central processing unit of each computer. In the data storage device is stored a data structure defining each participant object representation, which is the actor object. One constituent of the data structure is the position of the local actor in the virtual space, which is specified by three coordinates, (x,y,z) and an actor index of n. On every computer connected to the system, the computer must periodically recalculate the appearance of the virtual space. One part of the recalculation is to determine the position of each actor object representation, because the objects may all be moving. To accomplish this, each computer transmits to a central server the new position of the actor object representation associated with that computer. The central server retransmits this information to all of the other active computers that are working in the virtual space. Each of the active computers computes the motion of the actor objects corresponding to the received information. Each computer associated with an actor will have a point-of-view, which is the vector representing the virtual location of the screen in the simulated space.(5) Each computer locally calculates the appearance of the virtual space (5) for that actor by using its local position data and the position data of the other participants' object representations (5), (6). In another embodiment, the system operates in a peer-to-peer mode whereby each actor's computer broadcasts to the rest their respective position vectors rather than having the vector data pass through a central server. Similarly, the audio data streams and individual video data streams can be distributed peer-to-peer. In another embodiment, each of the computers directly broadcast to the other computers the vector information. The server can then be used to broadcast elements in the virtual space that are the same for all the computers.

The objects themselves can be rendered using typical graphics tools, that is the local position P(x,y,z) with an offset is used as the origin. For example, a computer can determine the locus of points constituting its actor's object by using the formula for a sphere with the center offset by some amount O(x,y,z). (1). Furthermore, the position of the viewing point relative to the local actor's object can be used to calculate the appearance of the entire virtual space. (5). The point of view is the location of the viewing point and the direction of the view. That is, each computer has a position for its viewpoint, position data for each actor object, position data for the other objects, and the shape definitions for each object. As a result, the computer can render a two dimensional view on the computer screen of the virtual space as viewed from that viewpoint. (5).

Movement of an actor object may be accomplished through the use of simulated physics. (15). Rather than having the actor object move with pre-calculated or pre-intended animation, a computer adapted to perform the invention would simulate physical interaction between the object, the space and the other objects in the space. For example, a sphere (1) can be imparted with a simulated mass. Essentially the object acts as a physics constraint shape following the actual actor position. A local physics engine (15) calculates new position vectors of the moving objects. This information used by the graphics rendering engine (16) to show simulated motion on the computer display (17). In the preferred embodiment, the Bullet (tm) software package is used.

The preferred embodiment periodically calls the following routine for each actor object (in this case, a sphere) as follows:

Vector3D(AB)=Vector3D(actor.position)−Vector3D(physics_sphere.position); RigidBody(physics_sphere).applyImpulse(Vector3D(AB)*Float(strength_factor)); Mesh(video_face_screen).setOrientation(Normalize(Vector3D(AB)));

The first line calculates the vector (50) from the current sphere position (100), with a display screen (200) to the new actor's position (300) that was received from the server (in the case of movement by a remote user that is to be displayed locally), or determined by virtue of input from the local computer user interface, e.g. trackpad, mouse, keyboard. (19). By the local user swiping the trackpad (or by using other input devices), a vector (50) is derived from the direction and speed of the swipe or other input. That vector is the new actor position, (300) which is used to calculate the motion of the actor object from the old position to the new one. In one embodiment, when such an input is detected and the vector calculated, that position vector is then encoded in a data message that is transmitted to the server, or, in the peer to peer mode, to all of the other computers. The data message is comprised of the position vector and a unique identifier associated with that actor in the space. The second line calculates the new parameters for the sphere based on applying the calculated vector to an impulse function. The magnitude of the impulse is modulated by the variable “strength factor.” This value is a constant that can be adjusted to optimize the overall feel of the environment. The third line of the routine moves the frame to the new position with an orientation set to the normal of the calculated vector.

This routine can be called whenever a new actor vector position is received or whenever the user inputs movement to be applied to the local actor. The routine can also be called on whenever the new actor position vector is not at the same place as the actor object. In this embodiment, the user computer captures the input of the user, e.g. audio input, video input and movement of the trackpad or other input device, and transmits this data to the server.

The invention also involves calculating the presence of collision detection between a static object and the actor object. When the calculation of edges determines that two objects share a common point, a collision is detected. At that point, the relative position of the centers of the two objects, their velocity vectors and other simulated physical attributes are used to calculate the response by feeding that data back into the simulated physics model. Typically, the simulated moving object will reflect from the collision point with the static object.

In one embodiment, the invention

Receives a new position P2(x,y,z) for actor(n) in the space (10);
Calculates a difference vector between the current position P1, (20), and the new position P2, (30);
Calculates a simulated physical movement of the actor object based on the calculated vector, (50), and pre-determined physical characteristics associated with the actor object;
Displays the simulated physical movement by using the calculated physical movement to drive real-time graphics calculations (16) from the viewpoint (5).

In addition, the invention calculates instantaneous changes in the audio rendering based on the relative positions of the objects. For example, the audio output of a user's computer loudspeaker would be a linear combination of all the audio associated with the actors. The coefficients of the linear (or other) combination would determine the relative volume levels of each aural source. The coefficient for the level of an aural source would increase in value as its distance came closer to the local actor's object and decrease in value as the distance increased. A physically accurate rendering would set the coefficient proportional to the inverse square of the simulated distance.

The image frame that occupies the interior of the actor object can be projected with a still image or a video data stream. (40). In order to do so, the position of the frame is calculated. The frame can be defined as a 3 dimensional mesh. The frame's center may be defined to be coincident with the center of the actor object or at some fixed vector from the center. Its orientation is defined by a vector normal to the surface of the frame. The vector can be fixed in orientation to the sphere so that if the physical model imparts spin to the sphere, the frame rotates in orientation along with the sphere spin. In another embodiment, the orientation of the image screen inside the object is totally separated from the object orientation, the object moves freely about the simulated surface. Further, by making the frame center coincident with the sphere center, the physics of the sphere's motion is imparted to the motion of the frame making the frame appear to be a physical part of the sphere.

In another embodiment, the relative spin of the actor object, which may be a sphere, can be impacted by motions of the mouse or track pad. For example, a rapid swipe from left to right can import a faster spin on the sphere. A slower swipe would result in a slower spin. In another embodiment, the orientation vector is associated with the actor position, as distinct from the actor object. The orientation of the actor results in the perceptual changes.

The simulated physics can include friction, so that spin imparted on the sphere so that the spin slows down over time. Similarly, a swipe motion on the computer track pad to impart velocity on the sphere will result in a velocity that slows down over time, by means of simulated friction. All of the parameters are parametric so that there are fixed coefficients that can adjust the overall amount of the velocity, spin and slowing down to establish a natural feel.

In one embodiment of the invention, the process:

Reads the position of the center of the actor object;
Reads the orientation of the actor;
Calculates the normal vector for the frame based on the actor orientation;
Calculates the apparent locus of points constituting the frame based on the read position and read orientation;
Calculates a projection of an image onto the frame based on the position of the viewpoint relative to the position of the frame and the normal vector.
Renders the projected image on the screen display.

An important aspect of the invention is that the calculations associated with the local actor object also applies to all of the other actor objects whose data is received. In other words, the procedure to calculate the position and orientation of the local actor object (1) also applies to distant actor objects that are participating in the space. The locally received position vector and movement vectors are used to calculate locally the new positions and orientations of the other actor objects (5), (6). The results are used by the graphics 3D rendering engine (16) with the purpose to calculate the two dimensional projection that is the view of the simulated space from the viewpoint that is presented on the user's computer screen (5).

The more distant image frames can be rendered with lower video quality because the perspective requires them to be presented as much smaller. This can save bandwidth and processing time. In one embodiment, the rendering can be calculated to use projected perspective in order that the simulated space appears to the user to have true three-dimensionality.

The calculation of the positions of the actor objects, frames and other objects is done in approximately real-time, generally one cycle of calculation being performed per display frame and preferable at video frame rate. Frame rate is preferably 30 frames per second, but can be 24 frames per second or any rate above 15 frames per second to be practical.

Programmatically, a computer operating the process has a class defined that associates an image data object or a video data stream in real-time with that class, so that a given instance of the object class can have a video stream and that is the bitmap data of the video stream applied as a texture on the 3D Mesh material. This creates the frame object. The frame object can be associated with another instance of an object class, like a sphere, in order to have a sphere with a frame in it on which is projected either an image or a video. The physics constrained sphere can be of any spherical shape: sphere, platonic (as long as it has enough faces subdivisions in order to rotate). The screen can be of any shape and can receive any data stream. While the structure of the invention is presented in an object-oriented abstraction, other embodiments of the Invention include using other computer programming abstractions that produce similar results.

Similarly, the static objects can be classes that are associated with a video stream that is projected on the side of the object.

In the overall system, a central server (12) manages the simulated three dimensional space and sends data out to all of the clients. The clients (13) receive the parametric data from the server (12) and then locally calculate the motion for the new position for the local actor object. The user's computer also transmits up into the cloud the current best position for the actor object. The local computer first takes the data and uses a physics package (15) to model the motion imparted on the model. Typically, this will be motion encoded on a track-pad (or any other input device) (19). The output of the physics engine drives the graphics engine (16) which in turn sends data to the display in order to present the result (17), (5). Static objects, which are simulated objects not subject to collision or any kind of physical forces that occupy the space, (7) may be sent to the graphic rendering engine directly (18).

In one embodiment, the video or image data projected on the objects can be advertising. In that case, the central server, by virtue of the fact that it continually has access to the current positions of all of the actors in the simulated space, can determine which and how many of the participants computers will be rendering the advertising onto the screen. This data can be used to bill advertisers for their presence in the simulated space.

In another embodiment, the video feed for wall objects can be video data comprising advertising video data. In this embodiment, an opaque wall, whether external (7) on the interior of a room (3) may project an advertising video when an actor object enters the space. Similarly, an audio feed can be associated with the room that is triggered when the actor object enters the room. In this embodiment, a position vector for a local actor object is transmitted to the server. When the condition of that position being within a predetermined region is found, the server can then transmit back a video or audio stream that is associated with the object class constituting the wall of the virtual room or some other static or moving object that is inserted into the space. When the resulting data stream and other objects are rendered, the viewer will see the advertisement on the wall of the virtual room. The presence of the actor object can be tallied at the server as an ad impression for accounting purposes.

In yet another embodiment, the system can use voice recognition processes operating locally on the client to detect key words. A key word associated with a room or other location in the space can cause the actor object and the point of view to immediately be shifted to that location. In another embodiment, the other location is simply a vector that is used by the motion simulation to simulate movement to that the actor object then travels to that other location. For example, if the system hears “movie”, it might immediately transport the actor and actor object to the vicinity of a movie theater in the Simulated space.

This routine transmits the local actor position to the server:

/**
*Sending my position to the mmo server
**/
//Class: bethere.actor.Me line 73
//my timer is set to send a ″timer″ event every seconds (1000ms)
var MMOTimer:Timer = new Timer(1000);
MMOTimer.addEventListener(″timer″, function(evt:TimerEvent):void{
//getFollowed returns our ″actor″ followed by the physics sphere
var me:SceneMesh = Me.Instance.getFollowed;
//so every seconds thanks to ″sendMoveEvt″, I send my position and
orientation MMOClient.Instance.sendMoveEvt(me.position, new
Vector3D(me.worldDirection[0],me.worldDirection[1],
me.worldDirection[2])); });

This routine receives remote actor positions and renders their position in the simulated space:

/**
* retrieving remote actors positions in the room
**/
//Class: bethere.mmo.MMOClient.as line 145
private function handlePhotonEvent(event : Event) : void {
switch(event.type) {
case CustomEvent.TYPE:
var pos_event:CustomEvent = (event as CustomEvent);
if(pos_event.getCode( )==Photon.MOVE EVT)
{
if(Me.Instance.getMMOId !=pos_event.getActorNo( )){
try
{
//Creates Actor if doesn't find him locally
var actor:Actor =
RemoteActor.getByOTStreamName(pos event.getData( ).streamId);
}catch(err:Error)
{
break;
}
var pos:Vector3D = new
Vector3D(pos_event.getData( ).pos.x,pos_event.getData( ).pos.y,pos event.getData( ).pos.z)
;
if(!actor.getMMOId)
{
//This is the first update of the actor
actor.setMMOId = pos event.getActorNo( );
actor.setId = pos_event.getData( ).streamId;
actor. setInitialPosition(pos);
actor.addActorToScene( );
}else //this is a regular update
{
actor.getFollowed.setPosition(pos.x, pos.y, pos.z);
//actor.getFollowed.appendRotation((event as
PosEvent).getDir.x, Vector3D.X_AXIS);
}
}
}
break;
}
}

The following routine is used to position the actor object and orient the display screen:

//Class: bethere.actor.Actor line 190
//This method make the physics sphere getting the closest to the actor
position public function following( ):void
{
//we get the vector defined from physics sphere center position to
actor position
var_vector:Vector3D =
_followed.position.subtract(_shape_instance.position);
//we give impulse to the center of the physics sphere in the
direction defined by the precedent vector and the strength relative to
the lengh of the precedent vector
_shape_instance.physicsObject.applyImpulseToCenter(_vector.x,
_vector.y, _vector.z);
//we change position of the screen inside it so it remains inside the sphere.
_shape_screen.setPosition(_shape_instance.position.x,
_shape_instance.position.y,_shape_instance.position.z);
// we change the orientation of the screen
inside the sphere to the actor orientation.
_shape_screen.setOrientation(_followed.orientation);
}

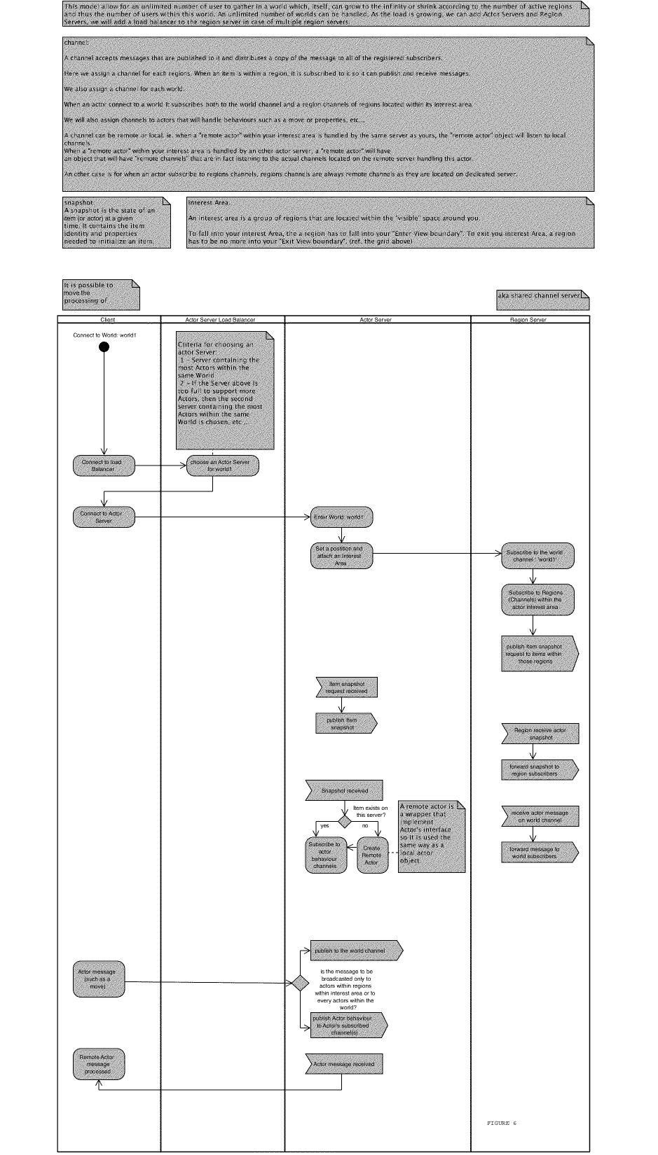

The basic protocol is depicted in FIG. 6. In this embodiment, the system allows for an unlimited number of users to gather in a virtual world which, itself, can grow to the virtual infinity in dimension or shrink according to the number of active regions defining a virtual geographic space and thus the number of users in this world. As the actors leave a region of the world so that no more actors are present in that region, the area of memory associated with the region can be deleted. An unlimited number of different virtual worlds can be managed using this process. As the load on the system grows, there can be additional servers, called Actor Servers that house the user's avator or actor and communicate with other users/actors in a shared world. The region servers can manage the aspects of the region that each user participating in that world will interact with. As the region or world grows, more region servers can be added. A load balancer to the region server can be used in case of multiple region servers.

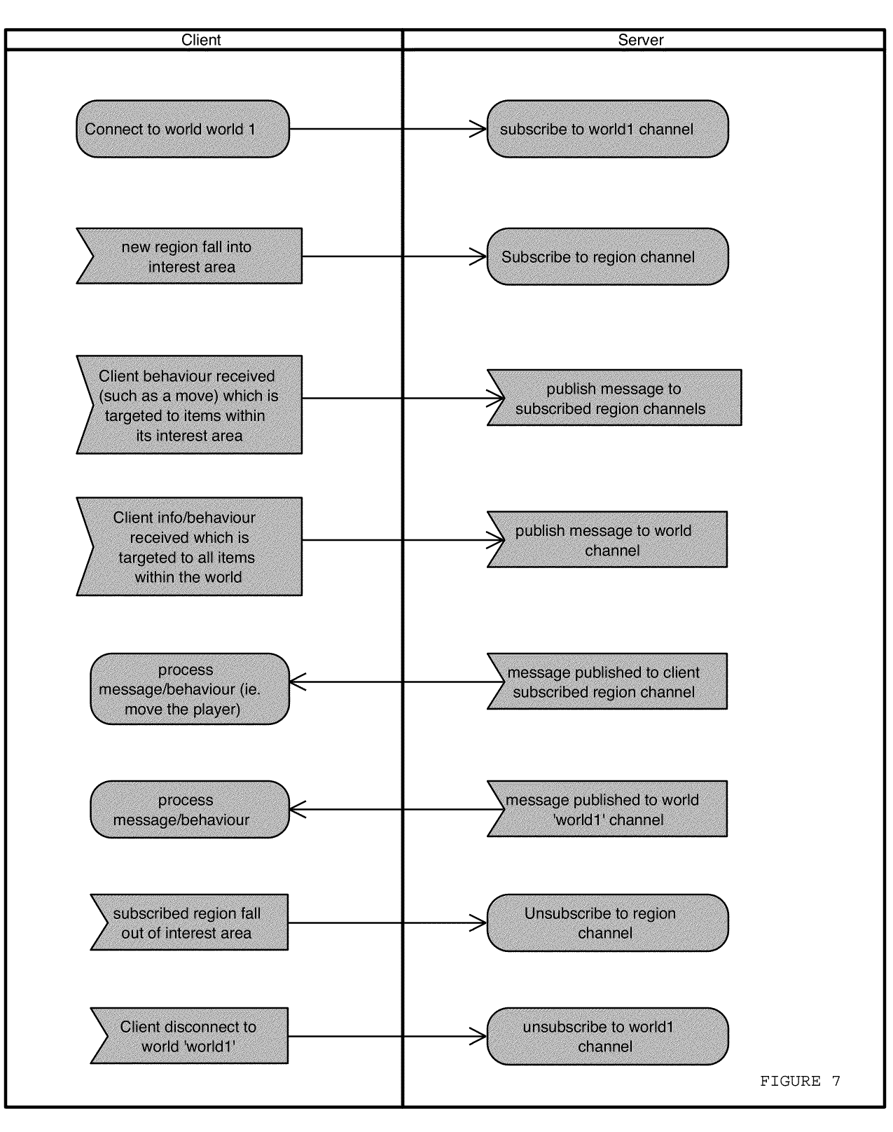

The criteria for choosing an actor server involves two steps: (1) The server containing the most actors within the same world and (2) if that is too full to support more actors, then the second server containing the next most number of actors within the same chosen world. FIG. 7 shows the various protocols that exist between the actor instance residing on the user's computer and the related actor instance housed on the one or more actor servers.

Once an actor server is identified for an actor entering a world, then a channel data structure is established on the region server, which accepts messages that are published to it from the actor and distributes a copy of the message to all the registered actors that are participating in the same region of the same world that the incoming actor is associated with. In addition, a remote actor is created on the actor server, which is a wrapper that implements the user's interface so that it can receive messages from its remote actor and take action on the local user's computer interface. In order to mitigate the possible explosion of data between all of the actors in a given world, the world is divided into regions, and each region is associated with a channel. Each actor is either subscribing to the channel or not depending on whether that channel is associated with an interest area that the given actor has signed up for. In this way, each actor instance only receives messages updating actions of other actors that are within the region and interest area that the receiving actor is operating in.
In yet another embodiment, the movements and actions of the actors and the changes to the regions and worlds can be sampled and stored so that processes taking place in the virtual world are recorded for playback in the future.
In yet another embodiment, the invention is adapted to provide load balancing among the various components of the system that comprise the invention. In particular:
on the client side:

class WorldEntered handles informations received from the server when we are in state world entered (ie. a remote player just subscribed/unsubscribed to a region located within our interest area, a new world parameter has been set, . . . )

class MyItem notifies the server about the local player behaviors (such as a move, or properties set, etc.)

class Avatar handles the visual part of the actor behavior (such as this physicalized sphere that follows the position of the player as we described earlier, . . . )

StreamAdapter is a base class for handling video playback (video chat but also all kind of video such as livestream.com or youtube)

class UserStreamAdapter handles part of video chat (we use the OpenTok API) management for a user (the other part is platform specific: flash/AS3, iOS/C/Objective-C—Android/Java to come—and can be found in folder “/unity/Assets/Plugins”). This class is used when a user subscribes or publish to a video session or when the user is remote and his volume needs to be regulated according to his distance from the POV, etc.):

On the server side:

class RemoteMessageChannel is the entry point of the Remote Message Channel explained in the UML diagram sent earlier.

class Region is a Remote Message Channel

class InterestArea manage the InterestArea behavior

### Operating Environment:

The system is typically comprised of a central server that is connected by a data network to a user's computer. The central server may be comprised of one or more computers connected to one or more mass storage devices. The precise architecture of the central server does not limit the claimed invention. In addition, the data network may operate with several levels, such that the user's computer is connected through a firewall proxy to one server, which routes communications to another server that executes the disclosed methods. The precise details of the data network architecture does not limit the claimed invention. Further, the user's computer may be a laptop or desktop type of personal computer. It can also be a video game console, a cell phone, smart phone or other handheld device. The precise form factor of the user's computer does not limit the claimed invention. In one embodiment, the user's computer is omitted, and instead a separate computing functionality provided that works with the central server. In this case, a user would log into the server from another computer and access the simulated space. In another embodiment, the user can operate a local computer running a browser, which receives from a central server a video stream representing the rendering of the simulated space from the point of view associated with the user.

In this embodiment, the user computer captures the input of the user, e.g. audio input, video input and movement of the trackpad or other input device, and transmits this data to the server. The server then calculates a bitmap for each upcoming video frame using this revised data. The calculation includes a perspective rendering for each user, calculated at such user's virtual location. The Server then translates individual streams out to the individual users, each stream then having the perspective associated with the destination user.

This technology allow for absolutely any platform that supports video with a tiny bandwidth connection to enjoy the benefit of the invention.

This may be housed in the central server or operatively connected to it. In this case, an operator can take a telephone call from a customer and input into the computing system the customer's data in accordance with the disclosed method. Further, the user may receive from and transmit data to the central server by means of the Internet, whereby the user accesses an account using an Internet web-browser and browser displays an interactive web page operatively connected to the central server. The central server transmits and receives data in response to data and commands transmitted from the browser in response to the customer's actuation of the browser user interface. Some steps of the invention may be performed on the user's computer and interim results transmitted to a server. These interim results may be processed at the server and final results passed back to the user.

The invention may also be entirely executed on one or more servers. A server may be a computer comprised of a central processing unit with a mass storage device and a network connection. In addition a server can include multiple of such computers connected together with a data network or other data transfer connection, or, multiple computers on a network with network accessed storage, in a manner that provides such functionality as a group. Practitioners of ordinary skill will recognize that functions that are accomplished on one server may be partitioned and accomplished on multiple servers that are operatively connected by a computer network by means of appropriate inter process communication. In addition, the access of the website can be by means of an Internet browser accessing a secure or public page or by means of a client program running on a local computer that is connected over a computer network to the server. A data message and data upload or download can be delivered over the Internet using typical protocols, including TCP/IP, HTTP, TCP, UDP, SMTP, RPC, FTP or other kinds of data communication protocols that permit processes running on two remote computers to exchange information by means of digital network communication. As a result a data message can be a data packet transmitted from or received by a computer containing a destination network address, a destination process or application identifier, and data values that can be parsed at the destination computer located at the destination network address by the destination application in order that the relevant data values are extracted and used by the destination application.

It should be noted that the flow diagrams are used herein to demonstrate various aspects of the invention, and should not be construed to limit the present invention to any particular logic flow or logic implementation. The described logic may be partitioned into different logic blocks (e.g., programs, modules, functions, or subroutines) without changing the overall results or otherwise departing from the true scope of the invention. Oftentimes, logic elements may be added, modified, omitted, performed in a different order, or implemented using different logic constructs (e.g., logic gates, looping primitives, conditional logic, and other logic constructs) without changing the overall results or otherwise departing from the true scope of the invention.

The method described herein can be executed on a computer system, generally comprised of a central processing unit (CPU) that is operatively connected to a memory device, data input and output circuitry (IO) and computer data network communication circuitry. Computer code executed by the CPU can take data received by the data communication circuitry and store it in the memory device. In addition, the CPU can take data from the I/O circuitry and store it in the memory device. Further, the CPU can take data from a memory device and output it through the IO circuitry or the data communication circuitry. The data stored in memory may be further recalled from the memory device, further processed or modified by the CPU in the manner described herein and restored in the same memory device or a different memory device operatively connected to the CPU including by means of the data network circuitry. The memory device can be any kind of data storage circuit or magnetic storage or optical device, including a hard disk, optical disk or solid state memory. The IO devices can include a display screen, loudspeakers, microphone and a movable mouse that indicate to the computer the relative location of a cursor position on the display and one or more buttons that can be actuated to indicate a command.

Examples of well known computing systems, environments, and/or configurations that may be suitable for use with the invention include, but are not limited to, personal computers, server computers, hand-held, laptop or mobile computer or communications devices such as cell phones and PDA's, multiprocessor systems, microprocessor-based systems, set top boxes, programmable consumer electronics, network PCs, minicomputers, mainframe computers, distributed computing environments that include any of the above systems or devices, and the like. The computer can operate a program that receives from a remote server a data file that is passed to a program that interprets the data in the data file and commands the display device to present particular text, images, video, audio and other objects. The program can detect the relative location of the cursor when the mouse button is actuated, and interpret a command to be executed based on location on the indicated relative location on the display when the button was pressed. The data file may be an HTML document, the program a web-browser program and the command a hyper-link that causes the browser to request a new HTML document from another remote data network address location. The HTML can also have references that result in other code modules being called up and executed, for example, Flash or other native code.

The Internet is a computer network that permits customers operating a personal computer to interact with computer servers located remotely and to view content that is delivered from the servers to the personal computer as data files over the network. In one kind of protocol, the servers present webpages that are rendered on the customer's personal computer using a local program known as a browser. The browser receives one or more data files from the server that are displayed on the customer's personal computer screen. The browser seeks those data files from a specific address, which is represented by an alphanumeric string called a Universal Resource Locator (URL). However, the webpage may contain components that are downloaded from a variety of URL's or IP addresses. A website is a collection of related URL's, typically all sharing the same root address or under the control of some entity. In one embodiment different regions of the simulated space have different URL's. That is, the simulated space can be a unitary data structure, but different URL's reference different locations in the data structure. This makes it possible to simulate a large area and have participants begin to use it within their virtual neighborhood.

Computer program logic implementing all or part of the functionality previously described herein may be embodied in various forms, including, but in no way limited to, a source code form, a computer executable form, and various intermediate forms (e.g., forms generated by an assembler, compiler, linker, or locator.) Source code may include a series of computer program instructions implemented in any of various programming languages (e.g., an object code, an assembly language, or a high-level language such as C, C++, C#, Action Script, PHP, EcmaScript, JavaScript, JAVA, or HTML) for use with various operating systems or operating environments. The source code may define and use various data structures and communication messages. The source code may be in a computer executable form (e.g., via an interpreter), or the source code may be converted (e.g., via a translator, assembler, or compiler) into a computer executable form. In addition, the code could be in the form of scripts on a webpage that are executed by the browser when it loads the webpage from a server.

The invention may be described in the general context of computer-executable instructions, such as program modules, being executed by a computer. Generally, program modules include routines, programs, objects, components, data structures, etc., that perform particular tasks or implement particular abstract data types. The computer program and data may be fixed in any form (e.g., source code form, computer executable form, or an intermediate form) either permanently or transitorily in a tangible storage medium, such as a semiconductor memory device (e.g., a RAM, ROM, PROM, EEPROM, or Flash-Programmable RAM), a magnetic memory device (e.g., a diskette or fixed hard disk), an optical memory device (e.g., a CD-ROM or DVD), a PC card (e.g., PCMCIA card), or other memory device. The computer program and data may be fixed in any form in a signal that is transmittable to a computer using any of various communication technologies, including, but in no way limited to, analog technologies, digital technologies, optical technologies, wireless technologies, networking technologies, and internetworking technologies. The computer program and data may be distributed in any form as a removable storage medium with accompanying printed or electronic documentation (e.g., shrink wrapped software or a magnetic tape), preloaded with a computer system (e.g., on system ROM or fixed disk), or distributed from a server or electronic bulletin board over the communication system (e.g., the Internet or World Wide Web.)

The invention may also be practiced in distributed computing environments where tasks are performed by remote processing devices that are linked through a communications network. In a distributed computing environment, program modules may be located in both local and remote computer storage media including memory storage devices. Practitioners of ordinary skill will recognize that the invention may be executed on one or more computer processors that are linked using a data network, including, for example, the Internet. In another embodiment, different steps of the process can be executed by one or more computers and storage devices geographically separated by connected by a data network in a manner so that they operate together to execute the process steps. In one embodiment, a user's computer can run an application that causes the user's computer to transmit a stream of one or more data packets across a data network to a second computer, referred to here as a server. The server, in turn, may be connected to one or more mass data storage devices where the database is stored. The server can execute a program that receives the transmitted packet and interpret the transmitted data packets in order to extract database query information. The server can then execute the remaining steps of the invention by means of accessing the mass storage devices to derive the desired result of the query. Alternatively, the server can transmit the query information to another computer that is connected to the mass storage devices, and that computer can execute the invention to derive the desired result. The result can then be transmitted back to the user's computer by means of another stream of one or more data packets appropriately addressed to the user's computer. In one embodiment, the relational database (I will use cloud storage services such as Amazon SimpleDB, this is most often not relational DB but Column-oriented/NoSQL DB) may be housed in one or more operatively connected servers operatively connected to computer memory, for example, disk drives. The invention may be executed on another computer that is presenting a user a semantic web representation of available data. That second computer can execute the invention by communicating with the set of servers that house the relational database. In yet another embodiment, the initialization of the relational database may be prepared on the set of servers and the interaction with the user's computer occur at a different place in the overall process.

The described embodiments of the invention are intended to be exemplary and numerous variations and modifications will be apparent to those skilled in the art. All such variations and modifications are intended to be within the scope of the present invention as defined in the appended claims. Although the present invention has been described and illustrated in detail, it is to be clearly understood that the same is by way of illustration and example only, and is not to be taken by way of limitation. It is appreciated that various features of the invention which are, for clarity, described in the context of separate embodiments may also be provided in combination in a single embodiment. Conversely, various features of the invention which are, for brevity, described in the context of a single embodiment may also be provided separately or in any suitable combination. It is appreciated that the particular embodiment described in the Appendices is intended only to provide an extremely detailed disclosure of the present invention and is not intended to be limiting.

The foregoing description discloses only exemplary embodiments of the invention. Modifications of the above disclosed apparatus and methods which fall within the scope of the invention will be readily apparent to those of ordinary skill in the art. Accordingly, while the present invention has been disclosed in connection with exemplary embodiments thereof, it should be understood that other embodiments may fall within the spirit and scope of the invention as defined by the following claims.

Code Modules that Execute One or More of these Functions are Disclosed Below:

The following code expresses the message passinve between the event and the channel:
using System;
using System. Collections. Generic;
using System.Linq;

{
base.Dispose( );

}

}

}
Interest areas are managed here:
namespace Photon.SocketServer.Mmo
{

using System;

using System.Collections.Generic;

using System.Linq;

using ExitGames.Concurrency.Fibers;

using Photon.SocketServer.Concurrency;

using Photon.SocketServer.Mmo.Messages;

using ExitGames.Logging;

using Common;

///<summary>

What is claimed:

1. A method executed by one or more computers of creating an interactive simulated space displayed on a computer, rendered from a point of view location in a simulated space comprising:
Receiving a plurality of position vectors in the simulated space associated with a plurality of corresponding actor objects;
Calculating a plurality of new location positions for each of the plurality of actor objects using the corresponding received plurality of position vectors;
Receiving a plurality of video data streams, each associated with a corresponding one of the plurality of corresponding actor objects;
Rendering each video data stream with a location, sizing and orientation consistent with the location and orientation of the corresponding actor objects, said rendering being done using the point of view.

2. The method of claim 1 further comprising:
Calculating the new location positions for the plurality of actor objects by using a physics model to simulate the dynamics of motion of the actor object.

3. The method of claim 1 where the video data stream is a single image frame.

4. The method of claim 1 where the video data stream is a moving image.

5. The method of claim 1 further comprising:
Receiving a plurality of audio streams, each associated with the corresponding plurality of actor objects; and
Mixing and rendering audio output based on relative levels of the plurality of received audio streams, said levels determined based on the simulated distance of each actor object from the point of view location.

6. The method of claim 5 where the mixing and rendering step are performed in stereo and the audio sources are positioned in the stereo field based on their apparent positions in the simulated space relative to the point of view.

7. The method of claim 5 further comprising determining that a source of audio in the simulated space is obscured from the point of view by an intervening simulated object and in dependence on such determination, setting the relative level of the audio signal of that audio source to substantially zero.

8. The method of claim 1 where the rendering step is to calculate the appearance using perspective projection.

9. The method of claim 1 where the rendering step is to calculate the appearance using isometric 3D.

10. The method of claim 1 further comprising:
Calculating for each of the plurality of vectors, an orientation for a video frame;
Displaying on the screen of the computer the simulated view from a pre-determined point of view of the simulated space, said view comprising the simulated video frame at the calculated orientation

11. The method of claim 10 further comprising:
Displaying on the simulated video frame a digital image.

12. The method of claim 10 further comprising;
Displaying on the simulated video frame a video data stream.

13. The method of claim 1 where the simulated object is one of: a sphere, a cube, a rhomboid, a cylinder, a cone, or an animal shape.

14. The method of claim 1 further comprising:
Calculating a vector that is the difference between the current object location and the new current actor location;
Calculating a motion of the simulated object based on the value of the calculated vector, said motion calculation based on a motion model.

15. The method of claim 14 where the motion model is substantially a Newtonian physics model.

16. The method of claim 1 further comprising:
Changing the point-of-view in order that the view follows the movement of the actor associated with the computer performing the calculation.

17. The method of claim 1 further comprising:
Detecting the condition of a collision between a first moving simulated object and a second simulated object;
Imparting apparent motion to the collided simulated objects in dependence on the relative motion of the two colliding objects.

18. The method of claim 1, 2 or 14 where the method is executed at a sufficient frame rate to impart the appearance of smooth motion.

19. A method of displaying a plurality of simulated objects in a simulated space on a plurality of computers, comprising:
Receiving from the plurality of computers a plurality of position vectors, each position vector associated with the plurality of computers;
Transmitting each of the plurality of position vectors received from its associated computer to the remaining of the plurality of computers in order to cause each computer to calculate for each of the remaining plurality of position vectors, a position for a corresponding simulated object; and display on the screen of the computer the simulated view from a pre-determined point of view associated with the computer of the simulated space, said view comprising the plurality of simulated objects located at their calculated positions in the simulated space.

20. The method of claim 19 further comprising:
Receiving a plurality of audio streams, each from one of the plurality of computers; and
Transmitting the plurality of audio streams to the remaining plurality of computers.

21. The method of claim 20 further comprising:
Further causing each computer to determine a plurality of levels for a corresponding plurality of audio signal data associated with a corresponding plurality of simulated objects, said determination being based on the simulated distances between the point of view and the plurality of simulated objects; and
Render a mix of the plurality of audio signals based on the relative plurality of levels.

22. The method of claim 20 further comprising:
Receiving data representing other simulated objects intended to appear in the simulated space.
Transmitting to the plurality of computers data representing other simulated objects to be displayed as part of the simulated space.

23. The method of claim 20 further comprising:
Transmitting data representing images to the plurality of computers in order to cause the computers to display the images on said other simulated objects.

24. The method of claim 23 where the images are advertising.

25. The method of claim 23 further comprising:
Transmitting data representing video to the plurality of computers in order to cause the computers to display the images on said other simulated objects.

26. The method of claim 25 where the video is advertising.

27. The method of claim 24 or 26 further comprising:
Determining the number of said computers that are displaying the simulated space such that the view includes the advertising in a legible form;
Storing the determined number.

28. The method of claim 19, 20 or 22 where each of the caused steps executed by the plurality of computers is executed at a sufficient frame rate to impart the appearance of smooth motion.

29. A method executed by one or more computers of creating an interactive simulated space displayed on a computer, the simulated space populated with actor objects associated with corresponding users, rendered from a point of view location comprising:
Receiving from a first user's computer data representing audio input, video input and motion input;
Receiving from at least one additional user's computer such at least one additional user's corresponding audio input, video input and motion input;
Retrieving from memory data representing the point of view for said first user;
Calculating a bitmap of a perspective rendering of the simulated space for said first user, calculated at the retrieved point of view, said perspective rendering including the appearance of the other at least one additional user's actor objects, image frames and their audio and video input;
Transmitting the bitmap data to the user's computer.

30. A computer readable data storage medium comprised of a hardware device containing digital data that, when loaded into a computer and executed as a program, causes the computer to execute any of the methods of claims 1 through 29.

31. A computer adapted by loading into memory and executing as a program digital data that causes the computer to execute any of the methods of claims 1 through 29.

32. A computer memory adapted to store a data structure, said data structure comprising:
a class that associates a video data stream in real time with a simulated three dimensional object that move together through a simulated space.

33. The computer memory of claim 32 where the data structure is a class object, said class object being comprised of:
a three dimensional object;
a video stream;
an Audio stream;
a text stream.

34. A computer system comprising a plurality of computers operatively connected using a data network, each of said computers comprising the system adapted to:
Receive a plurality of position vectors in the simulated space associated with a plurality of corresponding actor objects;
Calculate a plurality of new location positions for each of the plurality of actor objects using the corresponding received plurality of position vectors; and
Render each of the corresponding actor objects, said rendering being done using a pre-determined point of view corresponding to such computer.

35. The system of claim 34 further comprising an adaptation where each of said computers is adapted to:
Receive a plurality of video data streams, each associated with a corresponding one of the plurality of corresponding actor objects; and
Render each video data stream with a location, sizing and orientation consistent with the location and orientation of the corresponding actor objects, said rendering being done using the point of view.

36. The system of claim 34 further comprising an actor server and a region server.
